(19) United States
(12) Patent Application Publication
(10) Pub. No.: US 2012/0314781 A1
(43) Pub. Date: Dec. 13, 2012

(54) Powerline Control Interface for Frequency and Amplitude Modulation Transmitter

(76) Inventors: Didier Boivin, Santa Clara, CA (US); Michael Gaeta, La Valette du Vcer (FR)

(21) Appl. No.: 13/227,891

(22) Filed: Sep. 8, 2011

Related U.S. Application Data
(60) Provisional application No. 61/495,924, filed on Jun. 10, 2011.

(51) Int. Cl. H04B 3/54; H04L 27/04

(52) U.S. Cl. 375/257; 375/295

(57) ABSTRACT

An apparatus is disclosed where a Powerline interface is used to transmitting data into the powerline grid network, where the powerline interface is pulling the required transmit energy from the power grid network, where the powerline interface is transmitting data using standard modulation such as ASK, FSK, S-FSK, QPSK, OFDM, etc. . . where the transmit data are passed on to the powerline interface by the use of an adapation stage, where a “control signal” is used to enable the transmitting of data by providing enough voltage to polarize the FET used in the control path.

### CROSS REFERENCE TO RELATED APPLICATION

This application claims the benefits of priority under 35 U.S.C. 119© to the filing date of U.S. provisional patent application No. 61/495,924 entitled “New innovative Powerline Communication (PLC) solutions” which was filed Jun. 10, 2011 and is incorporated herein by reference.

### FIELD OF INVENTION

The present invention relates to a new type of Powerline Communication interface, also called power line coupler, and more specifically to an ultra low power, low cost Powerline Interface (PI) between a PHY standard modulation, demodulation (MODEM) and the power wires used to connect all devices in their eco-system (Alternating Current [AC] or Direct Current [DC] depending on the application).

### BACKGROUND OF THE INVENTION

As Utilities and other Energy Management Operators are looking at optimizing the electrical load of their grids and better manage energy peaks, “Intelligence” in the grid is making some in-road and is needed at every juncture of the grid in order to drive necessary change and innovation in support of a 21^{st}-century utility network—a “Smart grid” network.

To manage this new utility network, every point in the grid should be able to comprehend one of the three high-end layers of the smart grid network:
The Physical Layer mostly used for transmission and distribution
The Adaptation Layer mostly used for the communications of data and control
The Application Layer mostly used for applications and services. The focus of our invention is at the Physical Layer in PowerLine Communications (PLC) environment. Typically traditional PLC systems are injecting (“pushing”) data transmit power into the power line, which drives the power consumption of the system up to a few watts in some cases. As a result, the use of the PLC technology is limited to certain designs (form factor) due to power dissipation issues, and limiting the possible integration of the line coupler into a System on Chip (SoC).

Consequently the present invention was conceived to create an optimized Powerline Interface (PI) to transmit data on the power line by using (“pulling”) the required current (denoted: Current) from the power line and therefore reducing the overall power consumption of the transmit system to only few milli-watts required by the electronics of the PI and facilitating the deployment of standard modulation PLC solutions into forms factors that were not possible until now.

Furthermore, the use of the present invention is independent of the type of PHY modulation (ASK, FSK, S-FSK, BPSK, OFDM, etc. . . ) and with proper adaptation of some of the electronics; the invention can be used in different frequency bands relevant to the smart grid market, such as:
CENELEC A/B/C bands,
SAE bands,
Broadband Powerline communications frequency bands

### OBJECT OF THE INVENTION

The reason of the invention is to provide an ultra low power, low cost and small form factor Powerline Interface (PI) as part of a PLC Communication system which sits between a standard PHY modulation, demodulation (MODEM) and the power wires. The use of this new PLC communication PI is to connect all devices within their eco-system (i.e: a Photovoltaic Distributed Optimizer System). Like most of the traditional PLC communication system, the invention is used in an AC power environment, but can be used also in a DC power distribution network, thus depending on the applications.

An additional object of the present invention provides improvements in term of system power consumption by generating transmit signal (“Pulling”) from the power line versus existing PLC technology that drive transmit power (“Pushing”) into the power lines using inductive or capacitive coupling to the power wires.

Further object of the present innovation is to use a “control signal” to enable the transmitting of data by providing enough voltage to polarize the Transistor (FET) used in the control path. Therefore, the rhythm of the apparition of the modulation signal is controlled. Additionally, the voltage, when set to zero volt, disables all the transmit path of the system and therefore turn off the overall supply power needed for the transmit path.

Another object of the invention is to be able to use any existing modulation as part of the overall PHY modulation stage of the system. Standard modulations such as ASK, FSK, S-FSK, BPSK, OFDM, etc. . . within a defined frequency bandwidth can be transmitted through the use of the invention.

Further object of the invention is to leverage existing Receiver processing circuit (DSP) to receive data signals, which are compatible with existing system when using same modulation and frequency bands. Therefore, the invention allows to keeping some compatibility with systems already deployed in the field.

Further object of the invention provides a more desirable low cost, small form factor solution to provide a PLC line coupler due to the reduced number of components needed.

In addition to the above, the invention is also independent of the protocols used by the upper layers and can find its use in markets like, the Home Energy Management network, the Plug-In Electric Vehicles (PEV), the Photovoltaic (PV) solar power markets.

One can also use this invention in any DC environment like the PV optimizers, Home Automation (i.e: HVAC control system), AC/DC or DC/DC Power supply markets (i.e: it can be used in the context of “smart” power supply allowing a Grid operator to have a direct impact on the use or not of equipment in its network).

### SUMMARY OF THE INVENTION

Embodiments of the present invention is to create a method to generate Standard Transmit signal (“Pulling”) from the power line as it connects between two wires of the power network through a diode rectifier (to insure proper signal adaptation) followed by a Transistor (i.e: MOS FET) and Resistor circuit to significantly reduce the required power for the transmit stage for modulating the signal of a network voltage.

Further embodiment of the present invention is to reduce significantly the number of power rails on the board as the transmit stage is pulling power from the power line through the use of the Transistor (i.e: MOS FET) and Resistor circuit and therefore eliminating the need for a Transmit power supply rail (i.e: no need for a 12 Voltage rail).

Additional embodiment of the present invention is to use a Linear Amplifier to apply the Standard Modulation signal to the Transistor (i.e: MOS FET) and Resistor circuit in order to generate Standard Transmit signal (“Pulling”) from the power line. The use of a Linear Amplifier is to regulate the output voltage, which is creating a Current modulation to be applied to the Transistor (i.e: MOS FET).

Further embodiment is to apply a voltage (V+) during the transmission and to use some electronics to produce a threshold voltage allowing a Linear Amplifier to commute and then transmit the modulation signal to the Transistor (i.e: MOS FET) by creating the minimum power consumption for polarization of Transistor (i.e: MOS FET).

Further embodiment during the idle phase (reception), is to set the V+ signal to zero volt, reducing the overall supply power needed for the transmit pass.

It is desirable that the amplitude of the alternative voltage (AC) of the Power distribution network is greater than the threshold of the Transistor (i.e: MOS FET) to be polarized. This Current modulation is independent of the network impedance as long as it stays higher than the required voltage for the polarization of the Transistor (i.e: MOS FET) and resistance voltage.

One embodiment of the invention includes a synchronization circuit for monitoring the voltage carried by the network and supplying a synchronization signal for generating the signal on the power lines.

Embodiment of the present invention is to be able to generate some modulation signals leveraging Standard Modulation (such as ASK, FSK, S-FSK, BPSK, OFDM, etc. . . ) as they are used in many smart grid system and those being in the narrow frequency bands such as CENELEC bands. Large frequency bands are also supported with the present invention.

Further embodiment of the invention includes a processing circuit to receive data signals, which are compatible with system using same Standard Modulation (same modulation and frequency bands) than the present invention. Therefore, the invention allows to keeping some compatibility with systems already deployed in the field.

An additional embodiment of the present invention is the possibility to use the invention in a DC power distribution environment by using similar electronics concept to the AC system but without the front stage of the diode rectifier.

Furthermore, the present invention in the context of a DC power distribution environment supports the transmission of the signal in a continuous mode.

Embodiments of the present invention are directed to better control of the amplitude of the modulated signal, in particular with regard to electromagnetic compatibility rules of Electromagnetic Interference/Electromagnetic Compatibility (EMI/EMC).

### DESCRIPTIONS OF THE DRAWINGS

FIG. 1 shows a basic PV system with few panels and a centralized Inverter to perform the conversion of DC to AC.

FIG. 2 presents a conventional Powerline Communication coupler.

FIG. 3 presents a modified line coupler reflecting the embodiments bring by the present invention.

FIG. 4 shows an electrical circuit diagram of the line coupler reflecting the embodiments bring by the invention when use in an AC power distribution environment.

FIG. 5 presents an electrical circuit diagram of the line coupler reflecting the embodiments bring by the invention when use in a DC power distribution environment.

FIG. 6 shows experimental signals of the transmission chain. The situation is an AC grid presenting a 1 KHz frequency and 60 Volt peak-to-peak magnitude. The signal is a pure tone at 100 KHz and 1 Volt peak-to-peak magnitude.

FIG. 7 shows the grid voltage modulation (“V AC LINE”) based on the same modulation as shown in FIG. 6.

FIG. 8 shows the same period of time as shown in FIG. 7 and display the Current pull (“I AC line”) from the grid and its modulation corresponding the Signal.

### DETAILED DESCRIPTIONS OF THE EMBODIMENTS

The present invention will be better understood and fully appreciated when read in conjunction with the appended drawings. It should be understood, however, that the present invention is not limited to the precise arrangements and instrumentations as shown in the drawings.

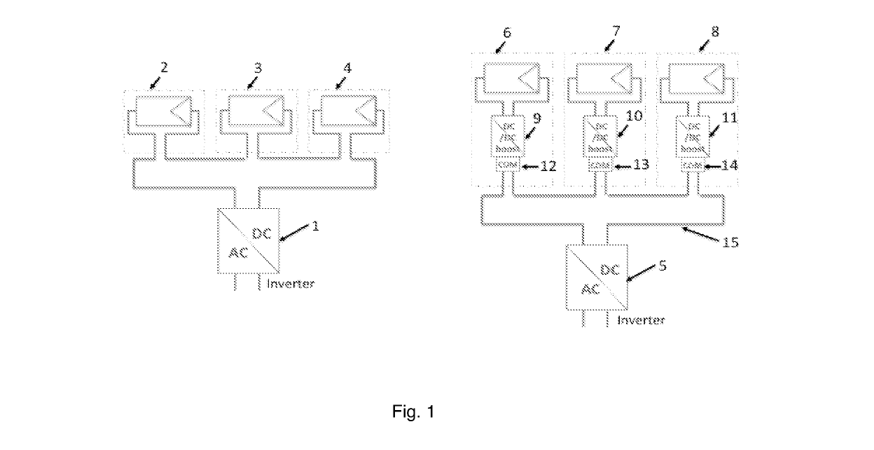

FIG. 1 is showing an example of the use of the invention in the context of a PV system. Over the last few years, performances improvements in the Photovoltaic markets drove the emergence of new technologies like micro-invertors and micro-convertors devices, which are becoming mainstream in the design of an energy efficient PV installation. The use of such devices allows to better compensating power lost due to various impairments such as shading, panel matching, soiling, etc. . .

FIG. 1 is showing a basic Photovoltaic approach leveraging a centralized DC/AC inverter 1 converting the unregulated generated DC power from the PV panels 2, 3 and 4.

One example of the benefits of the invention is within DC/DC micro-converters (called also DC optimizer and represented by 9, 10 and 11), which are converting the unregulated generated DC power from the PV panels 6, 7 and 8 into a fixed DC output voltage. This output voltage is fed into to the centralized DC/AC inverter 5 using a DC bus 15. One way of making sure the DC optimizer is efficient is by adding PLC Communication 12, 13 and 14 to respectively each DC optimizer 9, 10 and 11.

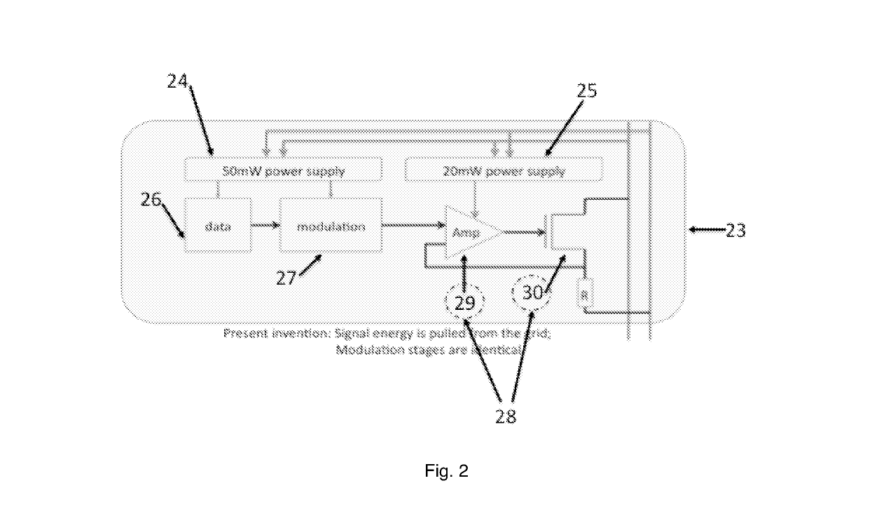

FIG. 2 shows a complete system 16 leveraging existing PLC technology for either narrow or large frequency band. Unfortunately, most of the communication system used today in the DC optimizers is a “Pushing” communication system 16 compare to our invention approach, which is a “Pulling” communication system 23. As a result by leveraging the present invention, systems, like PV systems, are a) most cost effective solution due to its reduced number of components; b) ultra low power energy inefficient communication solution due to the absence of powerline drivers in the communication interface; c) improving the performances of the overall PV installation due to need of less power supply for the overall system. Other advantages of this type of solution are security, remote management, etc. . .

In this system 16, Data 19 and Modulation 20 blocks are related to the Physical layer (PHY) and allow to generating modulation signals for the line coupler 22. Those signals are then pass on to a line driver 21 to create the transmit power signal to go through the line coupler (i.e: U.S. Pat. No. 7,078,982). Traditional line couplers are most of the time either inductive (using transformers) or capacitive (using capacitors). As mentioned in the FIG. 2, power supply 18 for these types of couplers can be up to few watts in the context of narrow frequency band system and even higher when using large frequency band system.

U.S. Pat. No. 7,078,982 provides a method wherein such high frequency oscillations are used to carry data through an electric network. The high-frequency oscillations are generated by the line coupler, comprising an electric element in series with a switch, the whole being connected between two wires of the electric network. A control signal carrying data is applied to the switch and alternately allows the switch to be closed and opened. Thus, the rhythm of the apparition of the high-frequency oscillations is controlled.

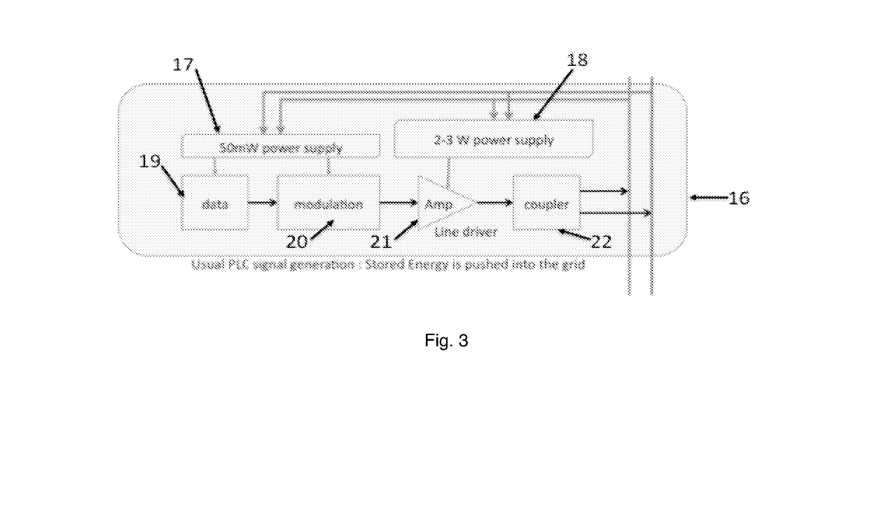

FIG. 3 shows a system 23 leveraging the present invention 28 which also support either narrow or large frequency band in any frequency band plan for transmission of Standard Modulation. In this new system 23, Data 26 and Modulation 27 blocks are related to the Physical layer (PHY) and are similar to the blocks shown in FIG. 2. The modulation signals for the line coupler are then going through a Linear Amplifier 29 uses to regulating the output impedance, which is creating a Current modulation to be applied to Transistor (i.e: MOS FET 30) which is pulling the transmit power from the power lines contrarily to the line coupler 22 in FIG. 2.

As a result (as shown in FIG. 3), power supply 25 requirement for this new system is only a few ten of milli-watts for both a narrow frequency band system and a large frequency band system.

The present invention allows improvements in term of types of modulation to transmit over power wires versus existing PLC technology leveraging similar “Pulling” type of coupling to the power line. Existing PLC technology generates transmit signal for “amplitude modulation” only by creating a single transmit Pulse (WO 2006/008381 International Application number) or by creating Multiple transmit Pulses (FR 08 01520 and U.S. Ser. No. 12/185312) for a single data bit versus the present invention which can support any Standard Modulations (such as ASK, FSK, S-FSK, BPSK, OFMD, etc. . . ) with limited frequency bandwidth depending on the chosen standard modulation (Standard Modulations).

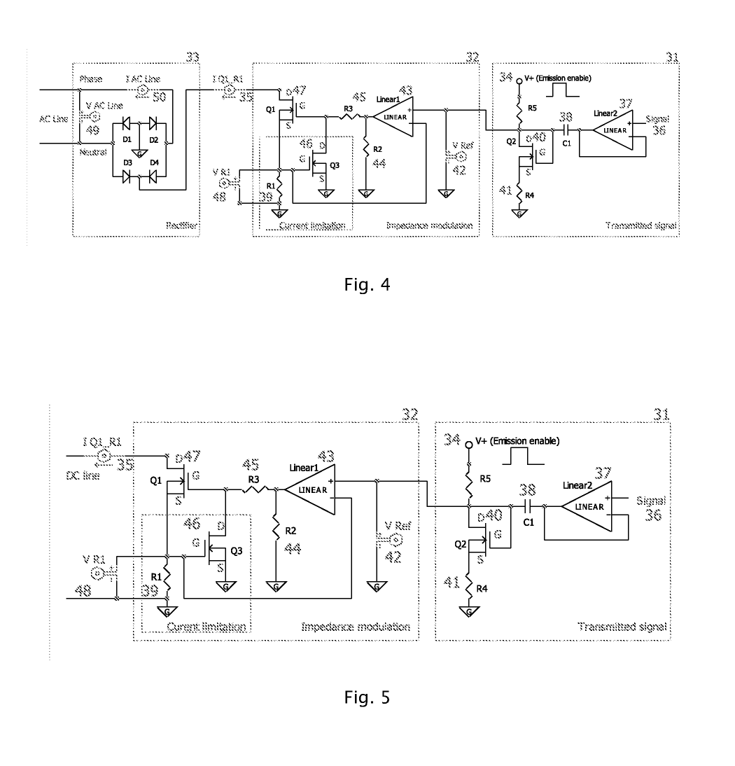

FIG. 4 shows a system representing the invention in the context of an AC power network. The description of the present invention is mostly related to the transmission part of a PLC system and is comprising of three (3) blocks for transmitting data through the line coupler:
The Transmitted signal block 31
The impedance Modulation block which include some Current limitation circuit 32
The rectifier, which is directly connected to the Phase and Neutral wires of the power line 33.

The transmit signal block 31 function is mostly to facilitate the adaptation of the Standard Modulation signal (Signal) to create enough voltage to be transmitted by the Impedance modulation block. Modulation type such as ASK, FSK, S-FSK, BPSK, OFDM etc. . . and those being narrow band or large band can be used with the invention.

The following considerations are critical to the invention:
A regulated generator of current is used and directly connected to the power supply 34 (V+). It is important to notice that 34 (V+) voltage can be at +3.3V, or +5V depending of the minimum voltage required to polarizing Transistors (i.e: MOS FET) 40 (Q2) and 47 (Q1).
The 34 (V+) connection is used as transmission enable signal.
During the transmission phase, 34 (V+) signal is active.
During the idle phase (reception), the 34 (V+) signal is set to zero volt to disable all the transmit path of the system and therefore reducing the overall supply power needed for the transmit path.
When 34 (V+) is active, the Signal is transmitted through 37 (Amp Linear2) and capacitive coupling 38 (C1) is used to adapt the Signal to the polarization stage.
Transistor (i.e: MOS FET) 40 (Q2) is then polarized to the threshold voltage allowing the 43 (Amp Linear1) to commute and then transmit this signal to the Transistor (i.e: MOS FET) 47 (Q1) and therefore creating the minimum power consumption for polarization of the Transistor (i.e: MOS FET) 47 (Q1). No power is transmitted on the line from the power supply. Only the coulombs to trigger the Transistor (i.e: MOS FET) 47 (Q1) are needed.
The Current draw by Transistor (i.e: MOS FET) 40 (Q2) has to be such that the transmit signal amplitude out of 43 (Amp Linearl) is less than the voltage at 41 (R4).
Modulation thru Transistor (i.e: MOS FET) 47 (Q1) is achieved by sending the data to modulate thru the “signal” pin 36 that will create the voltage for the command of Transistor (i.e: MOS FET) 47 (Q1).
The 43 (Amp Linear1) is regulating its output voltage, which is creating a Current modulation to be applied to Transistor (i.e: MOS FET) 47 (Q1).
The 43 (Amp Linear1) presents a feedback loop connected to 39 (R1), so the voltage at 39 (R1) is equal to the voltage “Vref” 42 at any time. The Current drained from the grid presents the same modulation than the desired Signal.
The resistor 44 (R2) is used to insure a proper use of the 43 (Amp Linear1).
The communication power is not provided by the transmitter as in traditional PLC solution but it is pulled from the use of the Transistor (i.e: MOS FET) 47 (Q1), 39 (R1) circuit and therefore allowing to reduce significantly the required power for the transmit stage and also reducing the complexity of power supply on the board (i.e: not need for a 12 Voltage rail).
This Current modulation (“I Q1_R1”) 35 is independent of the network impedance as long as it stays higher than the required voltage for the polarization of Transistor (i.e: MOS FET) 47 (Q1) and as long as grid impedance is higher than 39 (R1).
If needed or required by the application, a circuit for Current limitation can be added in the DC line loop. Resistor 45 (R3) & Transistor (i.e: MOS FET) 46 (Q3) are use to limit maximum Current through Transistor (i.e: MOS FET) 47 (Q1). The Transistor (i.e: MOS FET) 46 (Q3) V_{GS} is selected to limit Transistor (i.e: MOS FET) 47 (Q1) Grid tension and so to limit “I Q1_R1” 35.

FIG. 5 is showing the difference in terms of components required to make it works for a DC environment. Mostly what is needed is to remove the bridge rectifier (Rectifier 33) to insure proper signal adaptation with the following considerations related to blocks 31 and 32:
This new invention is able to transmit any Signal as long as the there is enough voltage to insure the proper polarization of the Transistor (i.e: MOS FET) 47 (Q1).
It is important to notice that 34 (V+) voltage does not have to be a similar voltage to the DC line voltage and can be the same as an AC system. Therefore it can be at +3.3V, or +5V depending of the minimum voltage to polarizing Transistors (i.e: MOS FET) 40 (Q2) and 47 (Q1).

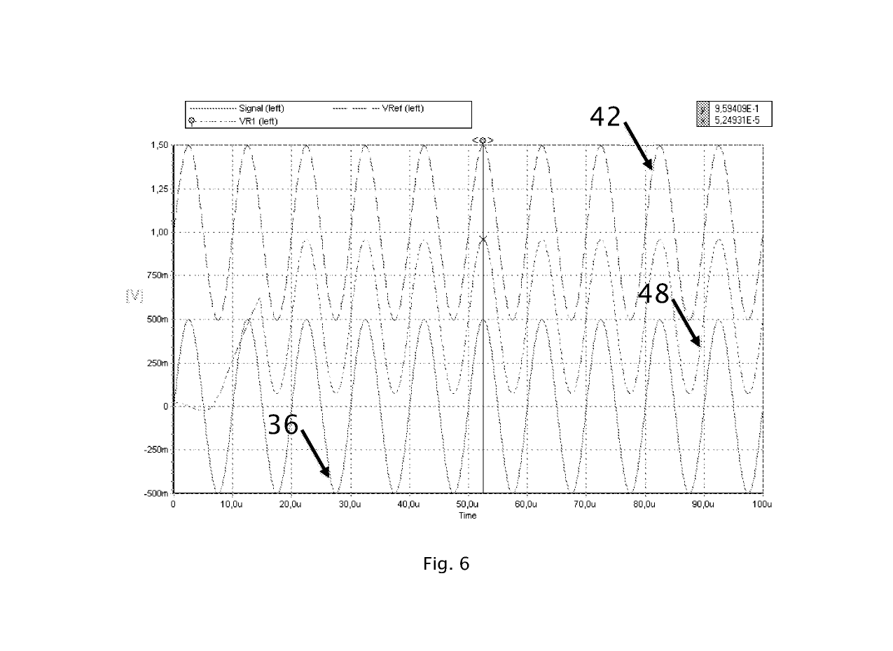

FIGS. 6, 7 and 8 show experimental signals of the transmission chain. The situation is an AC grid presenting a 1 KHz frequency and 60 Volt peak-to-peak magnitude. The signal is a pure tone at 100 KHz and 1 Volt peak-to-peak magnitude. This setting is chosen for figure comprehension and signal visualisation. The same result can be obtained using 50/60 Hz AC environment.

FIG. 6 shows how the original signal 36 (“Signal”) is added to some offset voltage (i.e. 1V) to obtain the “VRef” signal 42. This signal is then used to drives the coupler and creates at 39 (R1) a voltage noted “V R1” 48. The V R1 signal 48 presents the shape than the initial signal. The 39 (R1) value is 1 Ohm, so the driver is pull about 1 A from the grid with 100 KHz frequency modulation.

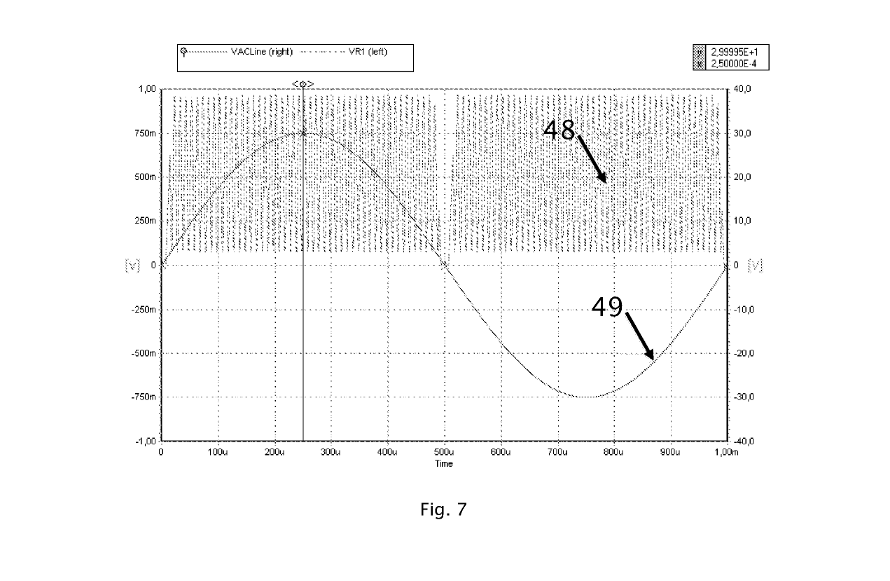

FIG. 7 shows the grid voltage modulation (“V AC LINE”) 49 for a complete period (1 ms). The “V R1” 48 follows the Signal modulation 36 except when the grid voltage is very low, lower value than the Transistor (i.e: MOS FET) 47 V_{DS} (Q1) polarization value (at zero crossing time). At that moment no signal is modulated.

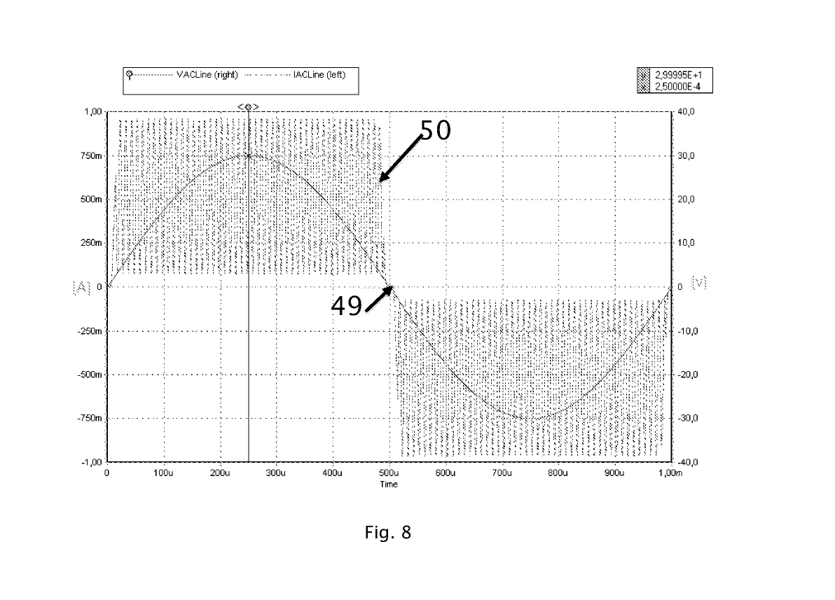

FIG. 8 shows the same period of time and displays the Current pull (“I AC line”) 50 from the grid and its modulation corresponding the Signal 36. This Current modulation is used for communication.

We claim:

1. A method to leverage power in an electrical network wherein a continuous modulated signal for communication purposes is transmitted by creating a current modulation.

2. The method of claim 1 wherein said current modulation has a coupler comprising of:
a. a Transistor connected to said electrical network;
b. an impedance in series connected to said Transistor wherein said impedance in series allows feed back information for said
Transistor V_{GS} regulation;
c. a linear amplifier used to control said Transistor current.

3. The method of claim 2 wherein said coupler further comprises a current limitation Transistor for electronic protection.

4. The method of claim 2 wherein said Transistor is connected to said electronic network through impedance.

5. The method of claim 2 wherein said linear amplifier controls said Transistor current through a Transistor driver.

6. The method of claim 2 wherein a minimum voltage sufficient for power consumption for polarization of the Transistor is applied through said linear amplifier.

7. The method of claim 6 wherein during idle phase a voltage of zero volt is applied through said linear amplifier.

8. The method of claim 2 wherein said electrical network further comprises a synchronization circuit for monitoring voltage carried by said network.

9. The method of claim 8 wherein said synchronization circuit further supplies a synchronization signal.

10. The method of claim 1 wherein said modulated signal is Standard modulation.

11. The method of claim 1 wherein said network further comprises a processing circuit to receive signals.

12. The method according to claim 2 wherein said coupler can be integrated into System on Chip.

13. The method according to claim 1 wherein said electrical network is Alternate Current.

14. The method according to claim 1 wherein said electrical network is Direct Current.

15. The method according to claim 1 is applicable to an electronic system managing DC/AC conversion.

16. The method according to claim 1 is applicable to an electronic system managing DC/DC conversion.

17. The method according to claim 1 is applicable to an electronic system managing AC/DC conversion.

18. The method according to claim 1 wherein said transistor is a MOS FET.

19. A apparatus for current modulation transmitting continuous modulated signal for communication purposes in an electrical network comprising of:
a. a Transistor connected to said electrical network;
b. an impedance in series connected to said Transistor wherein said impedance in series allows feed back information for said Transistor V_{GS} regulation;
c. a linear amplifier used to control said Transistor current.

20. The apparatus of claim 19 wherein said coupler further comprises a current limitation Transistor for electronic protection.

20. The apparatus of claim 19 wherein said Transistor is connected to said electronic network through impedance.

21. The apparatus of claim 19 wherein said linear amplifier controls said Transistor current through a Transistor driver.

22. The apparatus of claim 19 wherein a minimum voltage sufficient for power consumption for polarization of Transistor is applied through said linear amplifier.

23. The apparatus of claim 19 wherein during idle phase a voltage of zero volt is applied through said linear amplifier.

24. The apparatus of claim 19 wherein said network further comprises a synchronization circuit for monitoring voltage carried by said network.

25. The apparatus of claim 24 wherein said synchronization circuit further supplies a synchronization signal.

26. The apparatus of claim 19 wherein said modulated signal is Standard modulation.

27. The apparatus of claim 19 wherein said network further comprises a processing circuit to receive signals.

28. The apparatus of claim 19 wherein said coupler can be integrated into System on Chip.

29. The apparatus of claim 19 is applicable to an electronic system managing DC/AC conversion.

30. The apparatus of claim 19 is applicable to an electronic system managing DC/DC conversion.

31. The apparatus of claim 19 is applicable to an electronic system managing AC/DC conversion.
